(19) United States
(12) Patent Application Publication
(10) Pub. No.: US 2009/0314421 A1
(43) Pub. Date: Dec. 24, 2009

(54) DECORATIVE ARCHITECTURAL GLASS PANEL METHOD AND APPARATUS

(76) Inventor: Alex XIE, Colonia, NJ (US)

Correspondence Address: WALTER J. TENCZA JR., SUITE 210, 100 MENLO PARK, EDISON, NJ, 08837, US

(21) Appl. No.: 12/143,877

(22) Filed: Jun. 23, 2008

(51) Int. Cl. B32B 37/12

(52) U.S. Cl. 156/230; 156/379.8

(57) ABSTRACT

A method is provided including placing a first plurality of glass chips in a corresponding plurality of pockets of a first tray, and thereafter placing a first transfer sheet over the first plurality of glass chips while the first plurality of glass chips are in the corresponding plurality of pockets of the first tray. The first plurality of glass chips may be caused adhere to a first surface of the first transfer sheet, while the first transfer sheet is over the first plurality of glass chips and while the first plurality of glass chips are in the corresponding plurality of pockets of the first tray. The first transfer sheet may be lifted so that the first plurality of glass chips are lifted out of the corresponding plurality of pockets of the first tray. The first transfer sheet may then be placed with the first plurality of glass chips adhered to the first surface of the first transfer sheet onto a glass panel and the first plurality of glass chips thereafter may be adhered to the glass panel.

### FIELD OF THE INVENTION

This invention relates to methods and apparatus concerning the formation of decorative architectural glass panels.

### BACKGROUND OF THE INVENTION

There are various devices known in the prior art for forming glass mosaic panels.

### SUMMARY OF THE INVENTION

At least one embodiment of the present invention includes a method comprising placing a first plurality of glass chips in a corresponding plurality of pockets of a first tray. The method may further include placing a first transfer sheet over the first plurality of glass chips while the first plurality of glass chips are in the corresponding plurality of pockets of the first tray. The method may also include causing the first plurality of glass chips to adhere to a first surface of the first transfer sheet, while the first transfer sheet is over the first plurality of glass chips and while the first plurality of glass chips are in the corresponding plurality of pockets of the first tray. The first transfer sheet may be lifted so that the first plurality of glass chips are lifted out of the corresponding plurality of pockets of the first tray. The first transfer sheet may then be placed with the first plurality of glass chips adhered to the first surface of the first transfer sheet onto a glass panel so that each of the first plurality of glass chips has a first side which is adhered to the first surface of the first transfer sheet and a second side which contacts the glass panel, wherein the first side of each of the first plurality of glass chips opposes the second side. The method may also include causing the first plurality of glass chips to adhere to the glass panel, such as by glue which is activated as an adhesive by ultraviolet light. The first plurality of glass chips may be caused to adhere to the glass panel while the first transfer sheet adheres to the first plurality of glass chips. The method may further include removing the first transfer sheet.

The method may further include removing the first transfer sheet. The first plurality of glass chips may be caused to adhere to the glass panel while the first transfer sheet adheres to the first plurality of glass chips. The first plurality of glass chips may be caused to adhere to the glass panel by glue which is activated as an adhesive by ultraviolet light. The method may further include placing a second plurality of glass chips in a corresponding plurality of pockets of a second tray. The method may further include placing a second transfer sheet over the second plurality of glass chips while the second plurality of glass chips are in the corresponding plurality of pockets of the second tray. The second plurality of glass chips may be caused to adhere to a first surface of the second transfer sheet, while the second transfer sheet is over the second plurality of glass chips and while the second plurality of glass chips are in the corresponding plurality of pockets of the second tray. The second transfer sheet may be lifted so that the second plurality of glass chips are lifted out of the corresponding plurality of pockets of the second tray.

The method may further include placing the second transfer sheet with the second plurality of glass chips adhered to the first surface of the second transfer sheet onto the glass panel so that each of the second plurality of glass chips has a first side which is adhered to the first surface of the second transfer sheet and a second side which contacts the glass panel, wherein the first side of each of the second plurality of glass chips opposes the second side. The second plurality of glass chips may be caused to adhere to the glass panel, such as by glue which is activated as an adhesive by ultraviolet light. The first transfer sheet and the second transfer sheets may be translucent.

The present invention may also include an apparatus including a first plurality of glass chips, and a first tray having a plurality of pockets, wherein each pocket of the plurality of pockets is configured so that one of the first plurality of glass chips snugly fits into one of the plurality of pockets. The apparatus may also include a first transfer sheet having a first surface with an adhesive for adhering to the first plurality of glass chips. The method may further include a glass panel having a first surface with an adhesive onto which the first plurality of glass chips can be adhered. The adhesive on the first surface of the glass panel may be a glue which is activated as an adhesive by ultraviolet light. The first transfer sheet may be translucent.

### BRIEF DESCRIPTION OF THE DRAWINGS

FIG. 1 shows a top view of a molded tray for use in accordance with an embodiment of the present invention;

FIG. 2 shows a top, front, right, perspective view of the molded tray of FIG. 1;

FIG. 3A shows a top view of a glass sheet with score or cut lines to indicate where the glass sheet is cut to form glass chips for use with an embodiment of the present invention;

FIG. 3B shows a top, front, right perspective view of a glass chip cut from the glass sheet of FIG. 3A;

FIG. 4 shows a top, front, right perspective view of the molded tray of FIG. 1 with glass chips formed from the glass sheet of FIG. 3A, placed in pockets of the molded tray in accordance with an embodiment of the present invention;

FIG. 5 shows a top view of the molded tray of FIG. 1 with the glass chips formed from the glass sheet of FIG. 3A;

FIG. 6 shows a top, front, right, perspective view of a transfer sheet for use with an embodiment of the present invention along with the perspective view of FIG. 4;

FIG. 7 shows a top, front, right perspective view of the molded tray with the transfer sheet placed over the top of the molded tray;

FIG. 8 shows a bottom, front, right perspective view of the transfer sheet of FIG. 7 with glass chips obtained from the molded tray, transferred and attached to the transfer sheet;

FIG. 9A shows a glass panel with a plurality of transfer sheets with attached glass chips similar to or identical to the transfer sheet with attached glass chips shown in FIG. 8; and

FIG. 9B shows a glass panel with the glass chips attached to the glass panel, and with the transfer sheets removed from the glass chips.

### DETAILED DESCRIPTION OF THE DRAWINGS

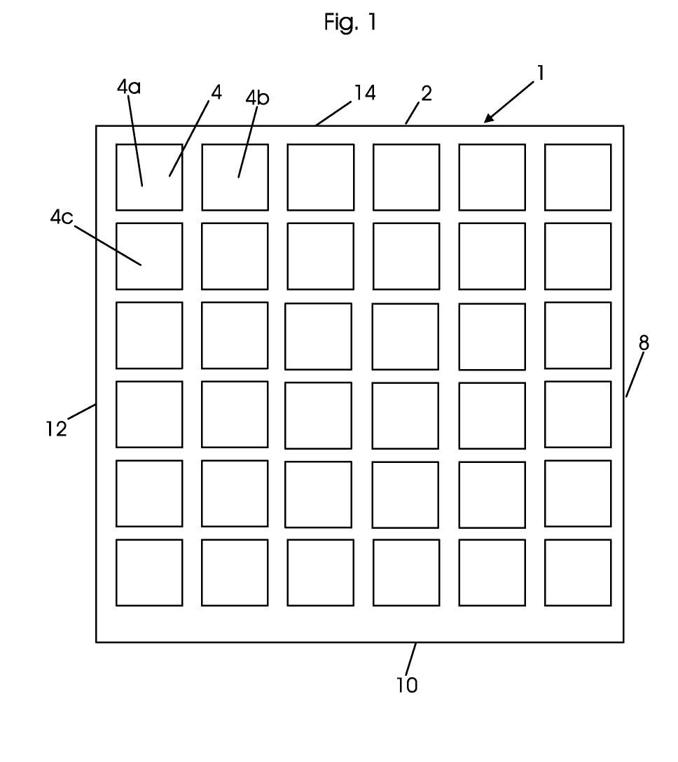

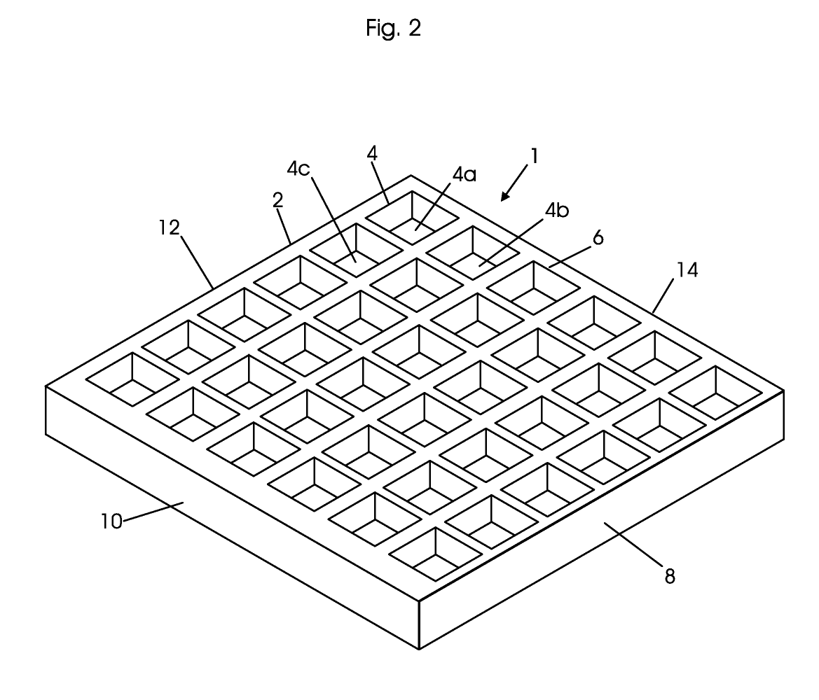

FIG. 1 shows a top view of a molded tray 1 for use in accordance with an embodiment of the present invention. FIG. 2 shows a top, front, right perspective view of the molded tray 1. The molded tray 1 includes body portion 2 and a plurality of pockets 4. The plurality of pockets 4 include pockets 4a, 4b, and 4c. The plurality of pockets 4 are arranged in a grid 6. The body portion 2 includes sides 8, 10, 12, and 14.

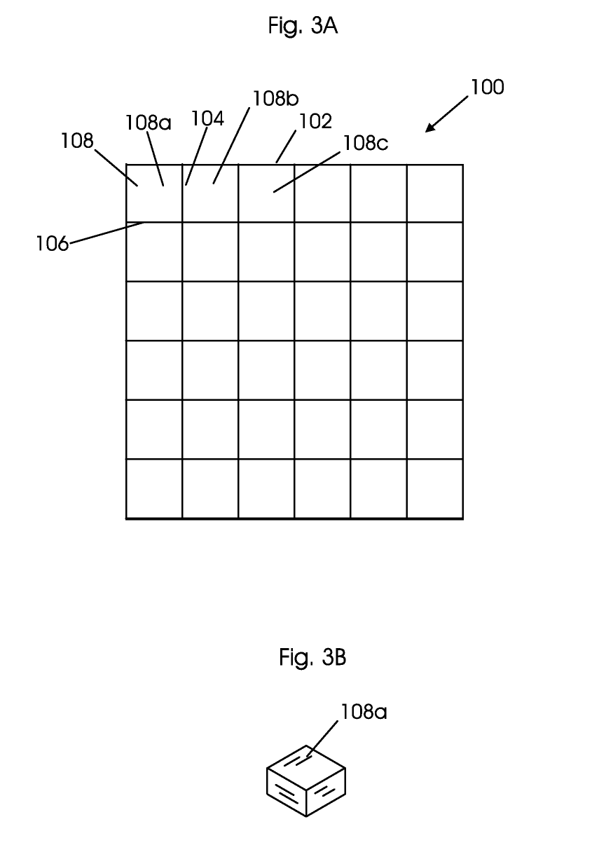

FIG. 3A shows a top view of a glass sheet 100 with score or cut lines, such as column cut lines 104 and row cut lines 106 to indicate where the glass sheet 100 is cut to form glass chips for use with an embodiment of the present invention. The glass sheet 100 is cut in a grid pattern 102 to form a plurality of glass chips 108, including glass chip 108a, 108b, and 108c. Glass chip 108a is shown in FIG. 3B and the other glass chips of glass chips 108 may be similar to or identical to glass chip 108a. FIG. 3B shows a top, front, right perspective view of a glass chip cut from the glass sheet of FIG. 3A. Instead of a substantially cubed shaped glass chip, as for glass chip 108a, the glass chips can be any other shape. In at least one embodiment, the glass chips, such as 108a, 108b, and 108c are cut from a variegated sheet glass. However, in other embodiments, the glass chips, such as 108a, 108b, and 108c can be pressed glass chips made using the method, system, and/or apparatus specified in U.S. Pat. No. 7,310,973 issued on Dec. 25, 2007 to Alex Xie, which is incorporated herein by reference.

In alternative embodiments, the plurality of pockets 4 can be arranged in shapes other than a rectangular grid 6 as shown. For example, the plurality of pockets 4 can be arranged in any shape such as an oval or fan shape. In addition, the glass chips such as glass chips 108a, 108b, and 108c can be, or can be replaced by chips of any size or shape desired. For example, instead of a square or rectangular shape for glass chip 108a, the glass chip 108 can be circular or oval or triangular or in any other shape or any other size.

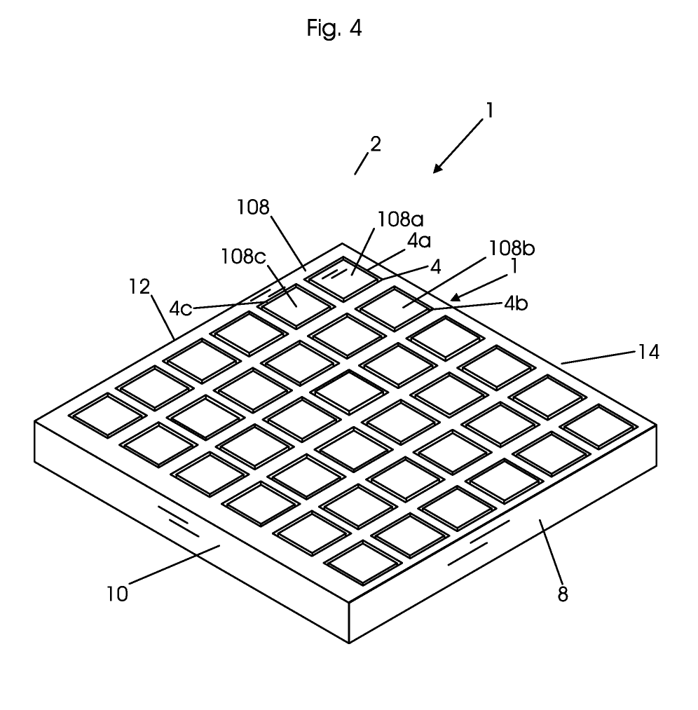

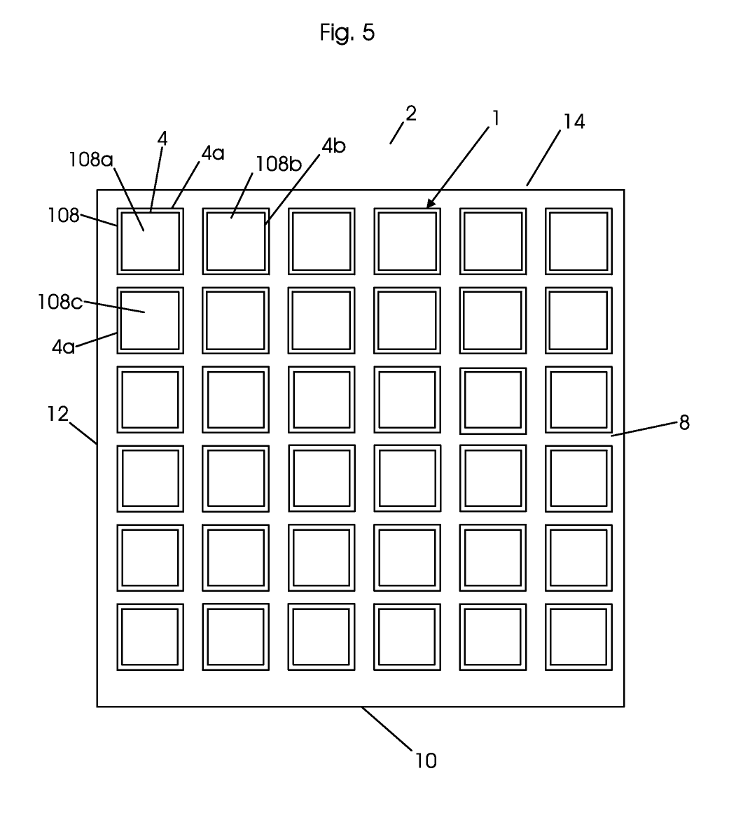

FIG. 4 shows a top, front, right perspective view of the molded tray 1 of FIG. 1 with glass chips formed from the glass sheet 100 of FIG. 3A, placed in pockets 4 of the molded tray 1 in accordance with an embodiment of the present invention. One glass chip, of glass chips 108, is placed in each of pockets 4 in one embodiment of the present invention. For example, glass chips 108a, 108b, 108c are placed in pockets 4a, 4b, and 4c, respectively, of the plurality of pockets 4. FIG. 5 shows a top view of the molded tray 1 of FIG. 1 with the glass chips 108 formed from the glass sheet 100 of FIG. 3A.

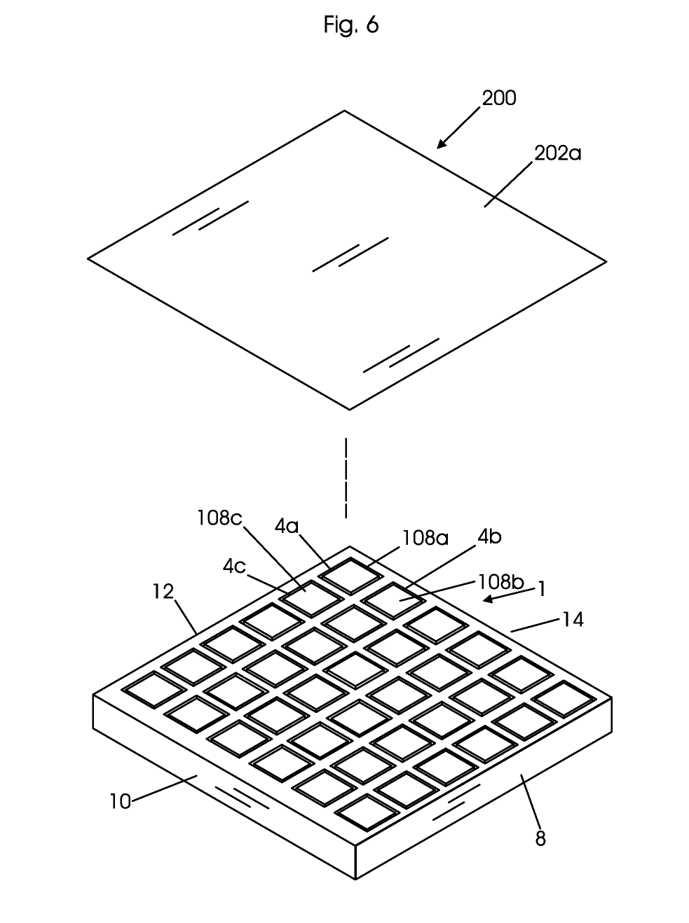

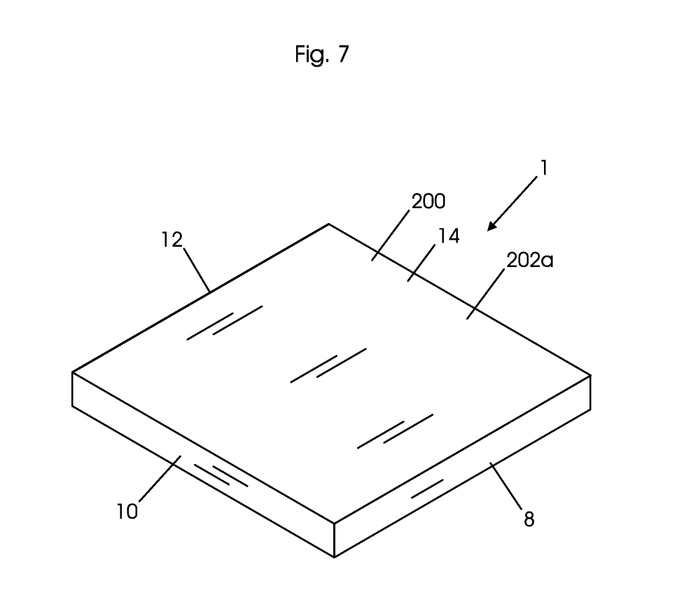

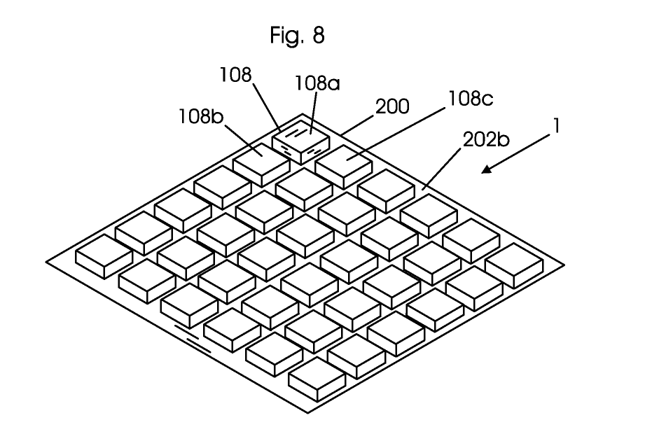

FIG. 6 shows a top, front, right perspective view of a transfer sheet 200 for use with an embodiment of the present invention along with the perspective view of FIG. 4 of the molded tray 1 and glass chips 108. In one embodiment, the transfer sheet 200 is placed over the molded tray 1 and over the glass chips 108 contained with the pockets 4 as in shown by FIGS. 6 and 7. The surface 202b (shown in FIG. 8) is pressed against the glass chips 108 in the pockets 4 of the molded tray 1. The glass chips 108 adhere and are attached to the surface 202b and then can be lifted out of the pockets 4 and out of the molded tray 1. The transfer sheet 200 may be a film that has a weak adhesive on the surface 202b. Although the transfer sheet 200 appears to be opaque in FIGS. 6 and 7, this is merely for descriptive purposes, and it is preferred that the transfer sheet be a translucent and transparent sheet or film so that the glass chips 108 would be able to be seen through the transfer sheet 200 in FIG. 7.

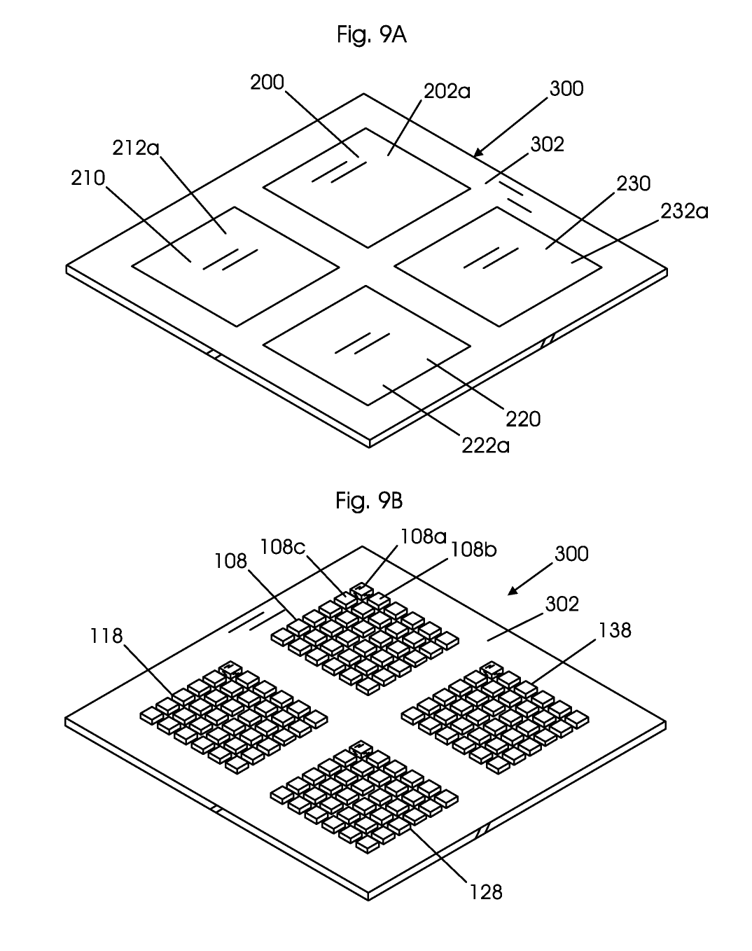

FIG. 9A shows a glass panel 300 with a plurality of transfer sheets, including transfer sheets 200, 210, 220, and 230 with attached glass chips (underneath the transfer sheets, glass chips not shown in FIG. 9A because they are covered by transfer sheets). The transfer sheets 210, 220, and 230 may be similar or identical to transfer sheet 200.

FIG. 9B shows the glass panel 300 with glass chips attached to the glass panel 300, and with the transfer sheets 200, 210, 220, and 230, removed from the glass chips 108, 118, 128, and 138. In one embodiment, the glass panel 300 may have a surface 302 on which is located a thin layer of glue or adhesive, such as ultraviolet (UV) glue. The glass chips 108, 118, 128, and 138 are pressed against and/or placed on the surface 302 of the glass panel 300 so that the glass chips 108, 118, 128, and 138 are glued to the surface 302. If ultraviolet (UV) glue is used on the surface 302, the glass chips 108, 118, 128, and 138 may be placed on the surface 302, so that they contact the glue, while the glass panel 300 and the glass chips 108, 118, 128, and 138 are in an area without UV light. After the glass chips 108, 118, 128, and 138 are all on the surface 302 as in FIG. 9B, then the surface of the glass panel 300 and the glass chips 108, 118, 128, and 138 are exposed to UV light which causes the UV glue to strongly bond the glass chips 108, 118, 128, and 138 to the glass panel 300 in a relatively short time.

In one embodiment the UV light may be applied while the transfer sheets 200, 210, 220, and 230 are located on top of the glass chips 108, 118, 128, and 138, as in FIG. 9A. In such an embodiment, the transfer sheets 200, 210, 220, and 230 are typically translucent and transparent, so that the glass chips 108, 118, 128, and 138 can be seen through the sheets 200, 210, 220, and 230.

After the glass chips 108, 118, 128, and 138 are glued to the surface 302 of the glass panel 300, and the transfer sheet 200 has been peeled off from glass chips, a transparent glue could be used as filler to fill in any spaces, and/or interstices between individual glass chips of the glass chips 108, 118, 128, and 138. A squeegee device or a wiper can be used to wipe off any excess glue that does not fit into the spaces or interstices. The transparent glue can be Ultraviolet light activated glue. In addition, conventional grout or some other filler material can be used to fill in the spaces and/or interstices, although this is not preferred.

In one or more embodiments, the glass panel 300 will typically be of a large size. Thus, in order to comply with safety codes, the glass panel 300 will usually be a tempered glass panel. The glass panel 300 is typically clear. The glass chips 108, 118, 128, and 138 in one or more embodiments will typically have variegated coloring, and could be any shape as desired. The glass chips 108, 118, 128, and 138 may be glass mosaic chips.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising
placing a first plurality of glass chips in a corresponding plurality of pockets of a first tray;
placing a first transfer sheet over the first plurality of glass chips while the first plurality of glass chips are in the corresponding plurality of pockets of the first tray;
causing the first plurality of glass chips to adhere to a first surface of the first transfer sheet, while the first transfer sheet is over the first plurality of glass chips and while the first plurality of glass chips are in the corresponding plurality of pockets of the first tray;
lifting the first transfer sheet so that the first plurality of glass chips are lifted out of the corresponding plurality of pockets of the first tray;
placing the first transfer sheet with the first plurality of glass chips adhered to the first surface of the first transfer sheet onto a glass panel so that each of the first plurality of glass chips has a first side which is adhered to the first surface of the first transfer sheet and a second side which contacts the glass panel, wherein the first side of each of the first plurality of glass chips opposes the second side;
causing the first plurality of glass chips to adhere to the glass panel.

2. The method of claim 1 further comprising
removing the first transfer sheet.

3. The method of claim 1 wherein
the first plurality of glass chips are caused to adhere to the glass panel while the first transfer sheet adheres to the first plurality of glass chips.

4. The method of claim 1 wherein
the first plurality of glass chips are caused to adhere to the glass panel by glue which is activated as an adhesive by ultraviolet light.

5. The method of claim 1 further comprising
placing a second plurality of glass chips in a corresponding plurality of pockets of a second tray;
placing a second transfer sheet over the second plurality of glass chips while the second plurality of glass chips are in the corresponding plurality of pockets of the second tray;
causing the second plurality of glass chips to adhere to a first surface of the second transfer sheet, while the second transfer sheet is over the second plurality of glass chips and while the second plurality of glass chips are in the corresponding plurality of pockets of the second tray;
lifting the second transfer sheet so that the second plurality of glass chips are lifted out of the corresponding plurality of pockets of the second tray;
placing the second transfer sheet with the second plurality of glass chips adhered to the first surface of the second transfer sheet onto the glass panel so that each of the second plurality of glass chips has a first side which is adhered to the first surface of the second transfer sheet and a second side which contacts the glass panel, wherein the first side of each of the second plurality of glass chips opposes the second side;
causing the second plurality of glass chips to adhere to the glass panel.

6. The method of claim 5 further comprising
removing the first and second transfer sheets.

7. The method of claim 5 wherein
the first and second plurality of glass chips are caused to adhere to the glass panel while the first and second transfer sheets adhere to the first and second plurality of glass chips, respectively.

8. The method of claim 5 wherein
the first and second plurality of glass chips are caused to adhere to the glass panel by glue which is activated as an adhesive by ultraviolet light.

9. The method of claim 1 wherein
the first transfer sheet is translucent.

10. The method of claim 5 wherein
the first and second transfer sheets are translucent.

11. An apparatus comprising
a first plurality of glass chips;
a first tray having a plurality of pockets, wherein each pocket of the plurality of pockets is configured so that one of the first plurality of glass chips snugly fits into one of the plurality of pockets;
a first transfer sheet having a first surface with an adhesive for adhering to the first plurality of glass chips;
a glass panel having a first surface with an adhesive onto which the first plurality of glass chips can be adhered; and
wherein the adhesive on the first surface of the glass panel is a glue which is activated as an adhesive by ultraviolet light.

12. The apparatus of claim 11 wherein
the first transfer sheet is translucent.
